(19) United States
(12) Patent Application Publication
(10) Pub. No.: US 2009/0139385 A1
(43) Pub. Date: Jun. 4, 2009

(54) MUSICAL INSTRUMENT AND SUPPORT

(76) Inventor: Jose Ngene, Birmingham (GB)

Correspondence Address: FRASER CLEMENS MARTIN & MILLER LLC, 28366 KENSINGTON LANE, PERRYSBURG, OH, 43551, US

(21) Appl. No.: 12/066,126

(22) PCT Filed: Sep. 8, 2005
(86) PCT No.: PCT/GB2005/003469

§ 371 Date: Mar. 7, 2008

(51) Int. Cl. G10G 5/00

(52) U.S. Cl. 84/327

(57) ABSTRACT

This invention relates to a musical instrument and a support therefor. More particularly, but not exclusively, the invention relates to a stringed musical instrument. The instrument comprises a body (102) and a neck. The body is covered in a resilient material, for example latex. The resilient material may be impregnated with particles, for example either, or both, of cis 1,4-polyacetate, or/and titanium dioxide. The body is covered in a resilient material that increases the longevity of a musical note and has a curved recess (114) formed in an edge of the body (102). The neck (104) has a number of nodules (124) spaced along it which allow a musician to check their fingering position without having to look at the neck (104). The recess (114) is arranged to receive a support (206). The support (206) is a projection from a belt (202) worn by the musician such that the weight of the instrument (100) is borne close to a musicians centre of gravity. Such an arrangement improves the musician's melodic choreography, as the centre of gravity of the musician and the instrument (100) varies as the musician moves. A complimentary support arrangement (200) is also disclosed.

This invention relates to musical instruments. It is particularly applicable to stringed instruments, such as guitars.

The design of musical instruments is very carefully carried out to ensure that the instrument produces the type of sound that is desired, and that the notes produced are sustained for the length of time required.

The present invention provides an instrument comprising a body at least partially covered with a resilient material.

The resilient material may be a polymer, such as latex or cis-1,4-polyacetate. The resilient material may be impregnated with particles, which are preferably harder, and preferably more dense than, the resilient material. For example the particles may be of a metal or a metal compound, such as a metal oxide, and are preferably of titanium dioxide.

In some embodiments, the resilient material can increase the longevity of a musical note produced from the instrument. This is because the use of a resilient material covering the body acts to redistribute the sound waves within the instrument thereby increasing the longevity of the sound waves within the instrument. The impregnation of the material with particles enhances this effect.

The invention is applicable to instruments wherein the body is hollow, and for example where the body is made of wood.

A musician often wants to move about a stage whilst playing their instrument, and also wants to execute complicated and expressive movements, for example dancing, whilst doing so. However, the use of a strap slung over the musician's shoulder to support the instrument limits the freedom of motion of the musician, restricting the musician's melodic choreography, as the centre of gravity of the musician and their instrument varies as the musician moves and the strap and instrument shift as a result of this movement.

Additionally, the musician may lose track of their finger position, for example on a fret board of a guitar, whilst moving about the stage and this can lead to the musician playing an incorrect note or looking away from the audience to the instrument in order to check their fingering, and can limit the musicians ability to vocalise in sync with the music, all of which are clearly undesirable.

According to a second aspect of the present invention there is provided a musical instrument comprising a body, the body having support bearing means, the support bearing means being arranged to receive a support such that the instrument is supported upon the support.

The support bearing means may comprise a recess in the body. The recess may be curved. The support bearing means may be arranged to receive an arm of a user or a support projecting from a garment worn by a user. The recess may be substantially U-shaped, may pass through both front and rear faces of the body, and may open through a side thereof.

The use of a recess in which the support is received removes the need for a strap arrangement to hold the instrument in place, thereby simplifying the construction of the instrument and allowing for the increased freedom of movement of a musician over current support arrangements. Additionally, the use of the recess to receive a musician's arm increases the freedom of the musician to position the instrument according to their needs.

The instrument may comprise grip means, typically arranged to receive a thumb of a user. The grip means may comprise a groove. The grip means may be formed of rhodium. Alternatively, the grip means may be formed of any suitable metal or a plastics material. The grip means may comprise a plate.

A thumb grip plate increase the ease with which a musician can hold the instrument. A groove allows sweat to run away from the grip plate increasing the stability of the users hold upon the instrument and the use of rhodium limits the corrosive effect of sweat upon the grip plate.

The instrument may comprise guide means, for example a plurality of nodules, arranged to provide a user with an indication of finger positions upon the instrument. The guide means may be mounted upon a neck of the instrument. The guide means may comprise a plurality of nodules. The plurality of nodules may be formed into groups and each group may be positioned to be indicative of fingering positions of a note or chord. Each of the plurality of nodules may have differing shapes and/or differing textures. The guide means may be mounted upon a neck of the instrument and may project laterally therefrom.

The guide means allow a musician to check their fingering position upon, for example, a fret board of a guitar without having to look away from the audience.

The body may be hollow. The body may be formed of wood, for example mahogany. The body may comprise a pick-up, typically a magnetic pick-up, which may be internal of the body. The instrument may comprise a guitar.

According to a third aspect of the present invention there is provided a support, suitable for supporting a musical instrument, the support comprising a support means and securing means arranged to secure the support means to a user, the securing means being arranged to be worn by a user, the support means projecting from the securing means and being arranged to support a musical instrument.

The securing means may comprise a belt, and may be in the form of a girdle arranged to be worn about a users pelvis. The securing means may be made of Lycra™ or any other suitable resilient fabric.

A belt, or girdle, is a convenient way to provide a support arrangement. The use of resilient fabric allows a ‘one-size’ fits all approach to manufacture thereby reducing the complexity of the manufacture process and reducing costs, and increasing the simplicity of supply chain management.

The support means may comprise a rigid projection, typically a plain cylinder of circular or elliptical cross-section.

The support means may be arranged to locate about the centre of the User's pelvis.

This supports the instrument at about the centre of gravity of the musician thereby increasing their ease of movement.

The present invention further provides an instrument comprising guide means arranged to provide a user with an indication of finger positions upon the instrument.

Preferred embodiments of the present invention will now be described, by Way of example only, with reference to the accompanying drawings, in which:

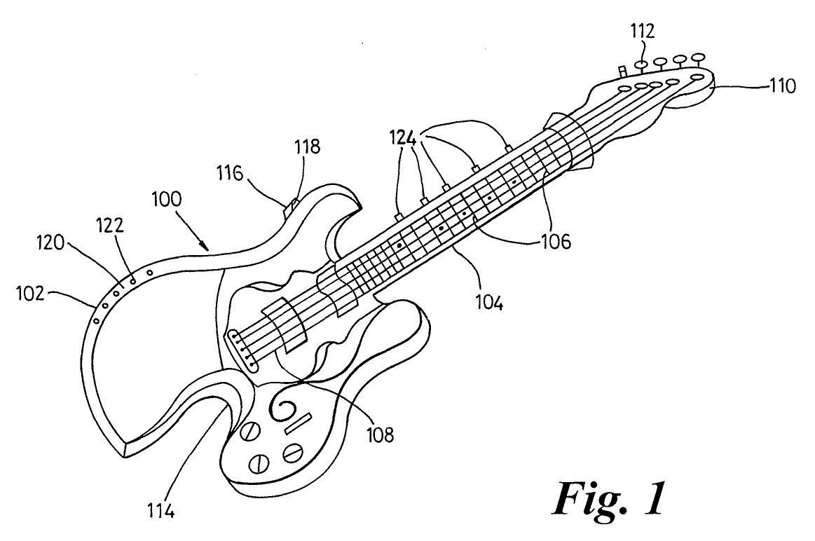

FIG. 1 is a front perspective sectional view of an embodiment of a musical instrument according to an aspect of the present invention;

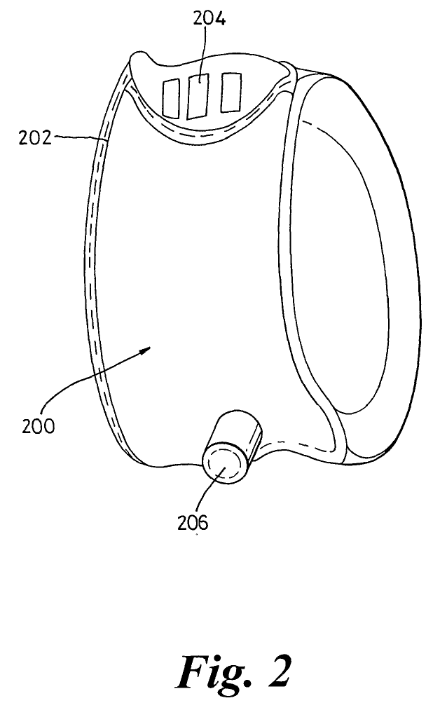

FIG. 2 is a perspective view of a support according to an embodiment of the present invention; and

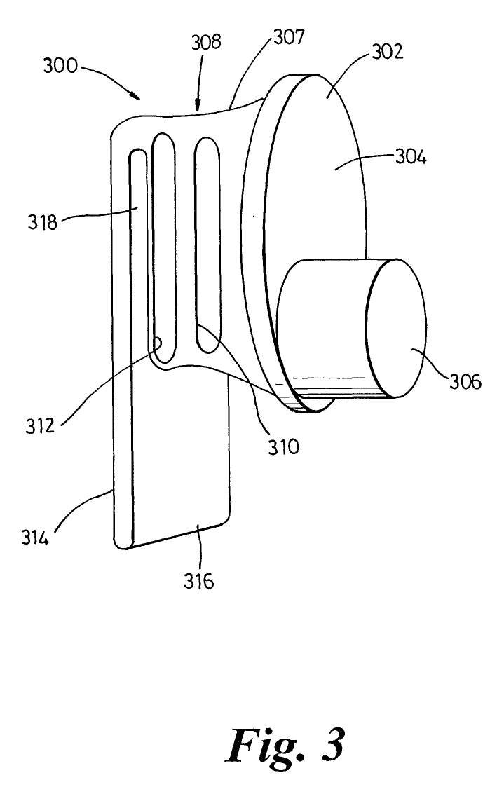

FIG. 3 is a perspective view of a support according to a further embodiment of the invention.

Referring now to FIG. 1, a guitar 100 comprises a hollow body 102 and a neck 104 with frets 106 thereupon. Strings 108 pass over the body 102 and up the neck 104 to a head 110 where they are tensioned by keys 112. The guitar 100 is played in a conventional manner and can be either an electric guitar or an acoustic guitar.

The periphery of the body 102 has a curved U-shaped recess 114 cut therein, opposite the neck 104. The recess 114 extends from the rear edge of the body 102, furthest from the neck 104, towards the centre of gravity of the body. The open rear end of the recess is just below the centreline of the body, along which the strings extend. The inner end of the recess is located at, or close to, the centre of gravity of the guitar 100. The recess 114 is sufficiently deep so as to receive a support, described hereinafter, or a musician's forearm with little opportunity for accidental movement of the guitar 100 from the support or the musicians forearm.

A rhodium thumb grip plate 116 is located on the edge of the guitar body above the strings and towards the front end of the body nearest the neck 104. The grip plate 116 projects upwards from the top edge of the body, typically towards an apex of a curved edge, of the guitar 100. The musician uses the plate 116 to rest his thumb on when handling the guitar 100 to increase the musician's grip upon the guitar 100. The plate 116 will usually have a groove 118 cut into it to allow for sweat from the musician's hand to drain away during energetic performances. The plate 116 is particularly useful in increasing grip where a musician is resting the guitar 100 upon their forearm by means of the recess 114.

The body 102 is typically made from 3 mm thick mahogany and is covered in a plastics material 120, typically latex, impregnated with titanium dioxide particles 122. The plastics material 120 can be cis-1,4-polyacetate instead of latex. The particles 122 act to divert sound waves generated by plucking of the strings 108 travelling across the surface of the body 102 back into the cavity of the body 102. This results in an increased longevity of a musical note, a sonic hold, which can be maintained without the necessity to use electric amplifiers, which can cause distortion, although it will be appreciated that amplifiers can be used if desired.

The thickness of the latex coating in this embodiment is about 1 mm, but thicknesses between about 0.5 mm and 2.00 mm or even O.1 mm and 3 mm can be used. Also the volume of the particles make up between 1% and 50% of the volume of the coating, preferably between 10% and 30%.

Titanium dioxide has a density within the range of 4.0 to 4.5×10³ Kg/m³, usually around 4.2×10³ Kg/m³. Densities of 4.0×10³ Kg m³ are found to give good sonic hold. Particles of other materials of density of at least 2×10³ Kg/m³ achieve similar results, with densities of at least 3×10³ Kg/m³ being preferable.

The thermal expansion of titanium dioxide is low, being about 8 to 10×10⁻⁶K⁻¹. Thermal expansion within this range is advantageous because it means that the particles do not expand significantly when the coating is heated prior to application to the body of the instrument. However, thermal expansions of less than 11×10⁻⁶K⁻¹ are satisfactory and materials with thermal expansion less than 15×10⁻⁶K⁻¹ are generally acceptable.

The neck 104 has guide nodules 124 spaced along, and projecting laterally from, the neck 104. The guide nodules 124 are typically spaced at the 3^{rd}, 5^{th}, 7^{th}, 8^{th}, 10^{th}, and 12^{th} frets 106 of the guitar 100 and consist of a number of projections that is the same as the number of the corresponding fret along the neck 104 In some embodiments the nodules may be of differing shape or length so that each nodule feels different to the touch. When playing the guitar 100 a musician can determine the location of the “note fingering” hand upon the neck 104, and consequently upon the frets 106, by feeling the guide nodules 124 whilst playing the guitar 100. This reduces the tendency of the musician to look to the frets 106, and away from an audience, whilst playing the guitar 100.

Referring now to FIG. 2, with reference to FIG. 1, a support 200 comprises a belt 202 having Velcro™ fastening strips 204 at each end thereof and a circular cylindrical support member 206 projecting therefrom. The belt 202 is typically fabricated from a stretchable material such as Lycra™. The support member 206 is located approximately half way along the length of belt 202 and midway between the edges of the belt 202 and typically is moulded onto the belt 202 for strength and stability. The support member 206 is arranged to project substantially perpendicular to the belt 202 and is about 10 cm long.

In use, a musician places the belt 202 about their pelvis and fastens the belt 202 in position using the fastening strips 204 such that the support member 206 projects substantially horizontally from adjacent the centre of musician's pelvis. The musician places the guitar 100 onto the support 200 such that the support member 202 is located in the recess 114. This arrangement maintains the centre of gravity of musician and guitar 100 combination close to that of the musician alone and thereby allows the musician to move freely, as though substantially unencumbered by the guitar 100.

It will be appreciated that the support 200 may in the form of a harness, strap, pants or any other suitable garment.

Referring to FIG. 3, in a further embodiment of the invention, a support 300 suitable for use with the guitar of FIG. 1 comprises a body 302 in the form of a disk with a circular front face 304. A circular cylindrical support portion 306 projects from the front face 304 of the body 302. An attachment portion 307 is formed on the rear of the disk shaped body 302. The attachment portion 307 has two narrow apertures 310, 312 extending through it in the horizontal direction substantially parallel to the front face 304 of the body. The attachment portion 307 includes a clip portion 314 connected to the top edge to the main part of the attachment portion 308 and extending downwards parallel to the rear surface of the main attachment portion, with its lower free end 316 extending past the bottom edge of the main attachment portion and the bottom edge of the body 302. There is a narrow gap 318 defined between the rear of the attachment portion, which extends through the support parallel to the front face 304 of the body 302, and is open at each side, and along its lower edge. The gap 318 is therefore only closed at its top edge, where the clip portion 314 is connected to the main attachment portion 308.

In use the support 300 can be carried on a belt worn by the user, typically a normal belt worn around the waist. The belt can be passed through one of the apertures 310, 312 before it is attached to the user. Alternatively the clip portion 316 can be pushed down behind the belt while the belt is being worn, so that the belt extends through the gap 318. In either case, the front face 304 will be supported in a substantially vertical position, and the support portion 306 will extend horizontally outwards from the hip area of the user. The guitar of FIG. 1 can then be supported on the support portion 306 in the same way as described above for the support of FIG. 2.

1-45. (canceled)

46. A musical instrument comprising a body at least partially covered with a resilient material.

47. An instrument according to claim 46 wherein the resilient material is a polymer.

48. An instrument according to claim 46 wherein the resilient material is impregnated with particles.

49. An instrument according to claim 48 wherein the particles are of a metal or a metal compound.

50. An instrument according to claim 46 wherein the body has support bearing means, the support bearing means being arranged to receive a support such that the instrument is supported upon the support.

51. An instrument according to claim 46 comprising grip means arranged to enable a user to hold the instrument.

52. An instrument according to claim 51 wherein the grip means has a groove formed therein.

53. An instrument according to claim 51 wherein the grip means comprises a plate.

54. An instrument according to claim 51 wherein the grip means is formed of rhodium.

55. An instrument according to claim 46 comprising guide means arranged to provide a user with an indication of finger positions upon the instrument.

56. An instrument according to claim 55 wherein the guide means comprises a plurality of nodules.

57. An instrument according to claim 55 wherein the guide means is mounted upon a neck of the instrument and projects laterally therefrom.

58. An instrument according to claim 46 wherein the instrument is a guitar

59. A musical instrument comprising a body, the body having support bearing means, the support bearing means being arranged to receive a support such that the instrument is supported upon the support.

60. An instrument according to claim 59 wherein the support bearing means defines a recess in the body.

61. An instrument according to claim 60 wherein the recess passes through both front and rear faces of the body, and opens through a side thereof.

62. A support, suitable for supporting a musical instrument, the support comprising securing means arranged to secure the support means to a user, and a rigid projection projecting from the securing means and being arranged to support a musical instrument.

63. A support according to claim 62 wherein the securing means comprises a belt arranged to be worn about a user's pelvis.

64. A support according to claim 62 wherein the securing means is adapted to be secured to a belt.
